(19) United States
(12) Patent Application Publication
(10) Pub. No.: US 2011/0140658 A1
(43) Pub. Date: Jun. 16, 2011

(54) Automated Parking Garage with Electric Vehicle Charging

(75) Inventors: Chris Outwater, Santa Barbara, CA (US); William Gibbens Redmann, Glendale, CA (US)

(73) Assignee: Liberty PlugIns, Inc.

(21) Appl. No.: 12/967,350

(22) Filed: Dec. 14, 2010

Related U.S. Application Data
(60) Provisional application No. 61/286,462, filed on Dec. 15, 2009.

(51) Int. Cl. H02J 7/00

(52) U.S. Cl. 320/109; 180/65.29

(57) ABSTRACT

Systems and methods provide electric vehicle charging in a high-density parking system. A carriage receptacle is physically attached to a carriage of a high-density parking system. The carriage receptacle electrically connects to an electric vehicle supported by the carriage. A bay receptacle is physically attached to a bay of the high-density parking system. The bay receptacle electrically connects the carriage receptacle to a power source to provide electrical charging to the electric vehicle when the carriage is moved into the bay. An electrical vehicle charging request is received from a user at a controller of the high-density parking system. In response to the electrical vehicle charging request, the controller selects the carriage and the bay to provide electrical charging to the electric vehicle when the carriage is moved into the bay.

### CROSS-REFERENCE TO RELATED APPLICATION

This application claims the benefit of U.S. Provisional Patent Application No. 61/286,462, filed Dec. 15, 2009, which is incorporated by reference herein in its entirety.

### BACKGROUND

1. Field of the Invention

The present invention relates generally to the field of automated, high-density parking garages and more particularly to an automated, high-density parking garage that allows charging of electric powered vehicles and hybrids.

2. Description of the Prior Art

An automated, high-density parking garage is a parking facility where an owner drops off a vehicle at some particular entrance location, and then carriages or mechanical systems that are part of the garage move that vehicle to a predetermined bay or storage location within the garage. When the owner wants to retrieve the vehicle, this request along with payment is usually entered into some sort of kiosk or terminal. The garage mechanical systems then retrieve the vehicle from the storage location and move it automatically to an exit location from where the owner can drive it off.

A particular example of an automated parking garage is taught by Haag in U.S. Published Application no. 2002/0164234. Here a multi-floor building has a number of storage racks for storing a pallet containing a vehicle. An entrance station on the ground floor resembling a small home garage acts as the entrance point. The vehicle is generally driven into this area and onto a pallet. After the owner has left the vehicle, the pallet holding the vehicle is shuttled mechanically horizontally and vertically in the structure until the correct parking storage rack is located. The vehicle is stored there until the owner requests it to be returned. Published application 2002/0164234A1 is hereby incorporated by reference.

The status of high-density metro parking is thoroughly discussed in a report issued by NARPAC entitled “High Density Metro Parking: The Missing Link in Public Transit: Public Parking. This report discusses the inefficiencies of current public parking and also introduces, inter alia, the idea of movable pallet systems. This report mentions that there are currently operable robotic parking systems in the U.S. in Washington DC and Hoboken N.J. The Hoboken system has been in use since May 2002. It is also well-known that there are several operable automatic parking facilities in Europe and other countries such as Dubai.

What is missing from these prior systems is the ability to charge an electric vehicle (EV) while it is parked. Fully electric vehicles as well as hybrids are becoming extremely popular with most major car manufacturers scrambling to introduce such vehicles. Several companies have had hybrids on the market for several years (such as the Toyota Prius). The missing link in society completely switching to electric vehicles is the difficulty in finding places to charge them on the road. While many such vehicles have good range, they nevertheless need to be charged. On-the-road charging facilities will become prevalent in the near future. Since charging an electric vehicle generally takes considerably longer than filling up the gas tank of a conventional one, an ideal place to charge is while the vehicle is parked, especially when it is parked in a parking facility.

It would be especially advantageous to have an automated parking facility that facilitated EV charging while the vehicle is parked. Such a facility should make it easy for an EV owner to charge, and should be able to optionally surcharge the owner an added fee for providing charging, and should be safe from the point of view of electrical danger and the removing of the charging cord before the car departs.

### SUMMARY OF THE INVENTION

The present invention relates to EV charging during parking at automated parking facilities. A patron approaching an automatic parking facility can indicate through a kiosk or a cellular telephone call that they desire EV charging while they park. They can also indicate voltages and charging rates desired. Payment can be made at that time, or later at retrieval. After parking on a pallet or other member, the patron or an attendant can plug the vehicle into the pallet. When the vehicle on the pallet is moved by the automatic parking system into a final position, the pallet or member can be electrified, and charging can begin. All charging can be metered and controlled by a central controller. High speed chargers can be managed within the system so that largest number of EVs can be charged. When charging is complete, the EV enabled pallet can optionally be moved to a non-EV enabled parking location to free up an EV enabled slot. Safety features such as break-away plugs can be used to make sure that a vehicle cannot leave the pallet or member without unplugging or to prevent a cord from snagging something inside the parking facility as a pallet is being moved. A cellular telephone call can alert a facility of the approach of a regular customer with caller ID so that an EV enabled pallet can be secured or a vehicle can be retrieved. A database can store parameters for such regular customers such as EV charging voltage, amperage and other charging information as well as managing billing for daily or monthly patrons.

### DESCRIPTION OF THE FIGURES

Attention is now directed to several figures that aid in understanding the features of the present invention.

FIG. 1 shows a schematic view of an automated parking facility with EV charging.

FIG. 2 shows an automobile on a pallet with a separable direct electrical interface to the pallet.

FIG. 3 shows an automobile on a pallet with an inductive power coupling.

FIG. 4 shows a control flow chart of an embodiment of a parking control process with EV charging.

FIG. 5 is an exemplary flowchart showing a method 500 for providing electric vehicle charging in a high-density parking system, in accordance with various embodiments.

FIG. 6 is a schematic diagram of a system that includes one or more distinct software modules to be executed on a controller of a high-density parking system so as to perform a method for providing electric vehicle charging in the high-density parking system, in accordance with various embodiments.

Several drawings and illustrations have been presented to further describe embodiments of the invention. The scope of the present invention is not limited to what is shown in the figures.

### DETAILED DESCRIPTION OF THE INVENTION

The present invention relates to automated parking systems that allow EV charging. By an automated parking system, we mean any system that can mechanically park or store a vehicle after the driver exits the vehicle. The most common type of automatic parking system uses pallets to hold and transport vehicles and lifts to take vehicles on pallets to and from different levels in the structure. Several of the embodiments presented herein involve pallet and lift systems; however, the scope of the present invention includes any automated parking system, no matter how it operates, that allows EV charging while a vehicle is parked.

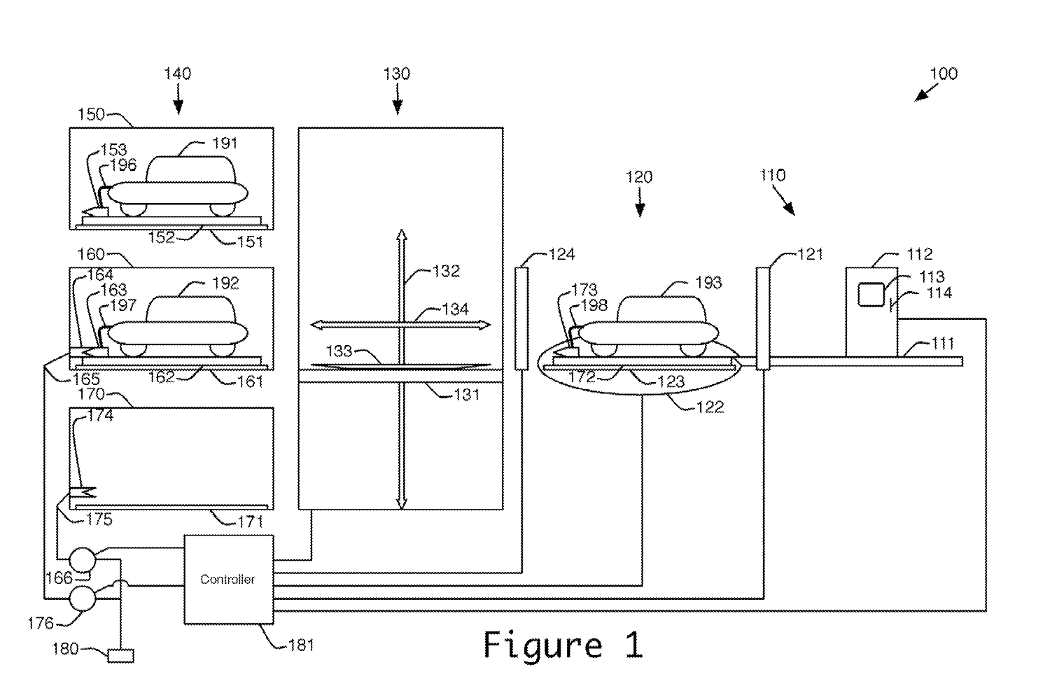

Turning to FIG. 1, a parking lift system with EV charging (100) can be seen. The system is generally divided into four distinct areas: an entrance/exit lane (110), an arrival/departure bay (120) which can be a single bay or two separate bays, a lift area (130), and a parking or storage area (140). A controller (181), which can be any type of processor or computer system, is connected to, and controls all four areas. While the connections in FIG. 1 are shown as solid lines, this does not imply that they are necessarily wire/cable or electrical connections; connections can also be wireless using any wireless technique known in the art.

Returning attention to the entrance/exit lane (110), an actual lane or path for a vehicle (111) can be seen. The entrance and exit can be separate lanes, or they can be a combination entrance/exit lane. A parking kiosk (112) is normally located where a driver can access it upon entrance. The parking kiosk (112) can include an internal processor of any type, or in the alternative, electronic control circuitry. The parking kiosk (112) generally contains a display screen (113) with a data-entry interface such as a touch screen, buttons, voice recognition, or a keypad. Any display device (or none at all), and any manner of data entry is within the scope of the present invention. The kiosk (112) can also have a payment acceptor (114) such as a credit card swipe or port or bill acceptor. A safety door (121) blocks entry into the next area, the arrival/departure bay (120). A driver entering the entrance lane (111) first communicates with the kiosk (112) and specifies whether he or she is interested in EV charging during the parking process or not. If EV charging is requested, the controller (181) can make sure that an EV enabled pallet is chosen and used for the vehicle. After the initial exchange of information with the kiosk (112) and optional advance payment, the safety door (121) opens, and the driver is allowed to drive onto a pallet (172) in the arrival/departure bay (120).

Once in the arrival/departure bay (120), the driver positions the vehicle (193) in the correct position on the pallet (172) usually by following instructions flashed on a lighted sign or panel (not shown) to indicate the correct position (green and red lights may also be used). A second safety door (124) is normally closed at this point. After the vehicle (193) is correctly positioned, the driver shuts off the engine and exits the vehicle. If the driver has requested EV charging, the pallet (172) is equipped with at least one, but preferably several electrical delivery boxes (173) in different locations around the pallet (172). The reason for multiple electrical delivery boxes is that different electric vehicles may have charging ports in different positions. The driver now plugs the electric vehicle (193) into the electric delivery box with a cable (198). This cable can either be supplied by the parking facility or by the driver. For example, in Europe it typically is specific to the vehicle and is supplied by the driver. The electric delivery box (173) may have several different electrical receptacles to accommodate different interface plugs used with different vehicles or different charging voltages or rates. The driver then exits the bay (120) through a pedestrian door (not shown) or via the entry door (121).

The EV charging enabled pallet (172) should be able to provide any type of receptacle, voltage or charging rate used with electric vehicles. At the time of initial information exchange at the kiosk (112), the driver can, in some embodiments of the invention, indicate what voltage or type of charge is desired.

In some embodiments, if the patron has not requested EV charging, a pallet that is not EV charging enabled may be provided in arrival bay (120) for parking the patron's vehicle (whether a non-EV or an EV for which the patron desires no charging). Such a pallet is otherwise interchangeable with EV charging enabled pallet (172), but does not have electrical delivery box (173).

After the system has verified that the driver is clear of the arrival/departure bay (120), the entrance door (121) closes, and the inner safety door (124) opens. The bay (120) can be equipped with rails (123) or other means of guiding and controlling the pallet (172) mechanically. The entry bay (120) may be equipped to move the pallet (172) into lift area (130), or this may be a function of equipment in the lift area (130), described below. The pallet (172) can be turned by a turntable (122) to face a correct direction and then be transported by the mechanical system into the lift area (130) which, once the pallet (172) is secure, can move the pallet horizontally (134) to address parking bays other than those shown, and/or vertically or optionally rotate the vehicle to face a different direction.

In general, the lift area (130) contains a transport lift or elevator (131) that is able to move pallets vertically (132) and/or horizontally (perpendicular to the plane of FIG. 1), loaded or unloaded, between any parking bay and the arrival/departure bay (120), or between any two parking bays (e.g., 150 & 170). The lift area (130) can also contain a transfer lift (133) capable of moving a pallet in a horizontal direction (134) to deposit or collect a pallet from a parking area or from the arrival/departure bay (120).

The parking or storage area (140) holds the parked vehicles and allows EV charging in some parking locations (160, 170). Some locations (150) may not have EV charging capability and are used for non-EV parking and for parking EVs that have completed charging or await a bay with charging capability. It is optional whether all parking locations have charging capability, or whether only some of the locations have this capability. The controller (181) makes sure that a vehicle that has ordered EV charging is eventually placed into a parking location that can supply electric charging if some locations do not have that capability.

The parking area (140) may contain empty locations (170) and full locations (150, 160). Vehicle (191) is shown in a parking location (150) that does not have charging capability. While the vehicle (191) is shown plugged in to the pallet (152) through a cable (196) and an electric delivery box (153), this box (153) is not making contact with any electrical source. On the other hand, vehicle (192) in location (160) is shown plugged into the pallet (162) with a cable (197) and an electric deliver box (163). In this case however, the electric delivery box (163) is shown mating with a power source (164) and hence is charging. Location (170) has a power source (174), but is empty. This parking location can be allocated to an arriving electric vehicle. In each of the parking locations (150, 160, and 170), rails (151, 161 and 171) are shown for supporting pallets. The pallets (152 and 162) are EV charging capable pallets since they have electric delivery boxes. Finally, each of the EV charging capable parking locations have electric meters (166, 176) that report electric usage from the power source (180) to the controller (181) so that detection of charging completion and/or proper accounting of parking fees can be made.

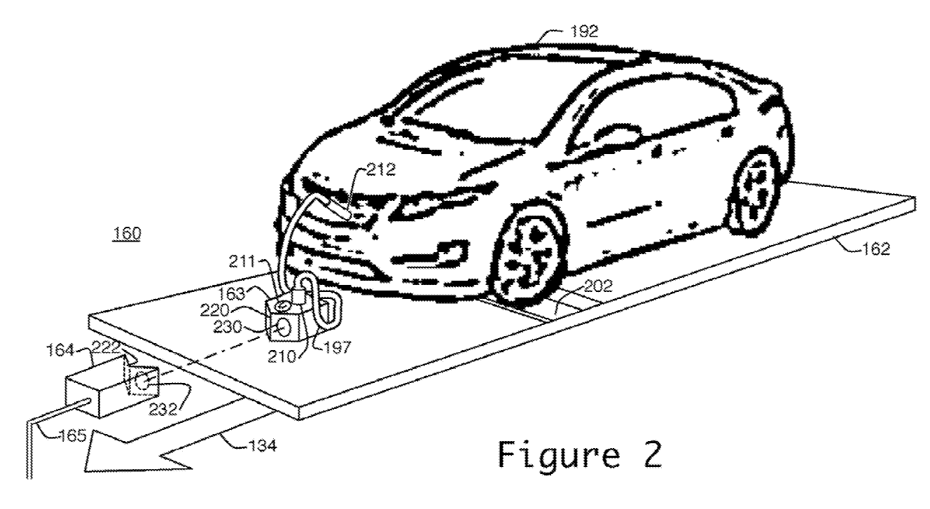

FIG. 2 shows an electric vehicle (192) on a pallet (162) in a parking location (160). An optional well or other retention device (202) helps keep the vehicle on the pallet. The vehicle (192) is connected to an electrical receptacle (210) on an electric delivery box (163) through a cable (197). The other end of the cable (197) is plugged into the vehicle with a plug (212) specific to that vehicle. A receptacle of a different type (211) is shown not being used. The embodiment of FIG. 2 includes an electric delivery box (163) of a type that mates mechanically and electrically with a power source portal (164) supplied with electric power through an electric cable (165). A pointed mechanical guide (220) mechanically mates with a mechanical receptacle (222) that makes sure the pallet is in proper alignment and electrical connections (230 and 232) are in the proper position. A power plug (230) mechanically and electrically mates to a power receptacle (232) as the pallet (162) moves in horizontal direction (134).

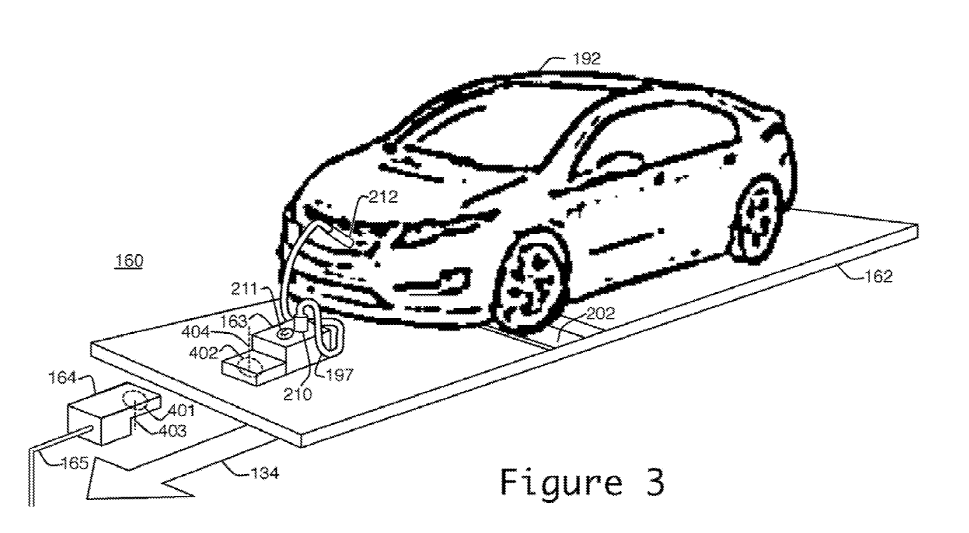

FIG. 3 shows an alternate method of coupling the electric delivery box (163) to the power source portal (164) that does not require a mechanical plug/receptacle pair between the electric delivery box and the power supply. In this case, an inductive primary coil (401) is located on the fixed power delivery portal (164), while a secondary coil (402) is located on the electrical delivery box (163). When the two coils come together so that the axis (403) of the primary coil is aligned with the axis (404) of the secondary coil, a transformer is created that transfers electrical energy by induction using the AC magnetic field.

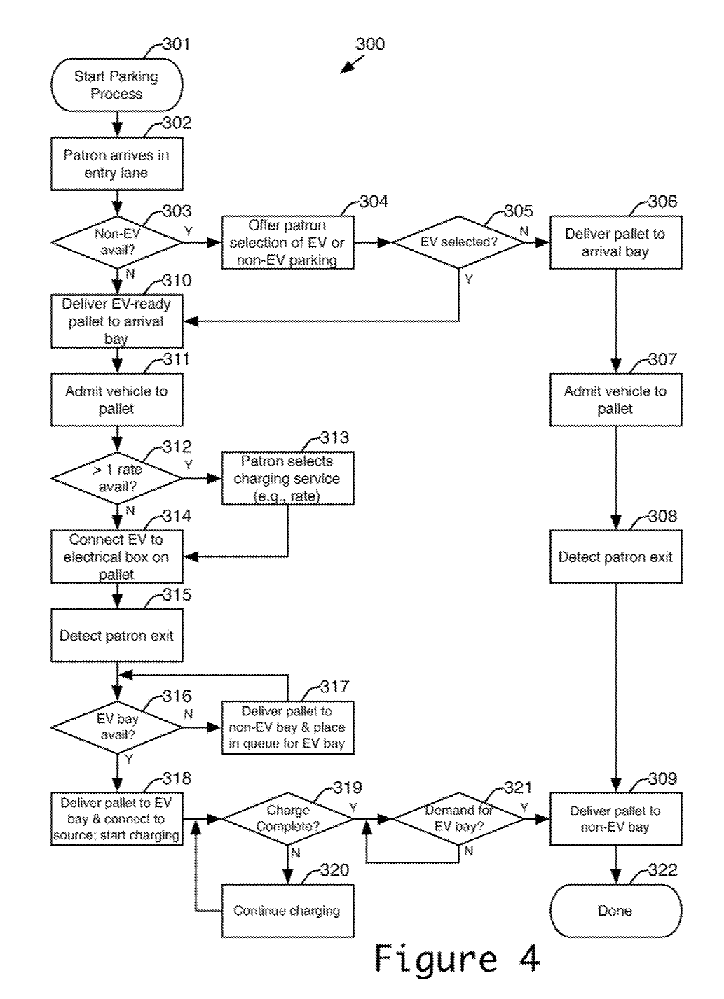

FIG. 4 shows a flow chart (300) of the process of providing automated parking with EV charging capability. The process starts (301) when a patron arrives in the entry lane (302). If parking for non-EVs is offered, (303) the patron is offered a selection (304) of EV or non-EV (or EV, but not charging) parking. If only EV enabled parking is offered, this step is skipped (303). If there is a selection, and EV is not selected (305) the pallet is delivered (306) to the arrival bay and put on a pallet (307) in the normal way. The exit of the patron (308) is detected, and the pallet with the non-EV (or EV to be parked without charging) can be delivered (309) to the non-EV storage bay.

On the other hand, if EV is selected (305), or there is no non-EV parking offered (303), an EV enabled pallet is delivered (310) to the arrival bay. The vehicle is admitted (311) and put on the EV enabled pallet. If there is more than one charging rate available (312), the patron can select (313) the charging service or rate. In any case, the patron connects (314) the vehicle to the proper electrical outlet on the pallet with a charging cable. The system detects (315) when the patron has exited the arrival bay and decides (316) whether an empty EV bay is available. If not, the pallet can be queued (317) waiting for an EV bay. The waiting can be in a non-EV bay or in a holding area. When (or if) an EV enable parking bay is available (318) the pallet is delivered there and connected to the power source, and charging begins. Charge is monitored (319, 320) until complete, at which time, if there is a demand for an EV bay (321), or such demand is anticipated, the pallet can be removed from the EV bay and delivered (309) to an non-EV bay until the patron reclaims the vehicle. If there is no demand (321), the vehicle can remain in the EV bay until either the vehicle is reclaimed, or there is a demand (321). This completes (322) the process for EV charging and parking.

While the figures have shown power receptacles on only the front of a pallet, it is important that receptacles appear at intervals around the perimeter of the pallet to accommodate different locations of charging ports on different vehicles. In some embodiments of the invention, receptacles of different voltages and amperage capability can be staggered around the pallet. For safety, it is preferred to use female receptacles. For example, female connection boxes can be countersunk into the railing or into the corners of a pallet to allow pallet stacking and to provide compatibility with other pallets.

Also, while the preceding descriptions stated that the patron can plug the vehicle in for charging, this function can also optionally be handled by a human attendant. Also, while the charging cable can be supplied by the vehicle owner, it is desirable that the parking facility supply them. This way, additional safety can be achieved by using break-away plugs in case the driver drives off the pallet without unplugging the vehicle (many electric vehicles will not start if the cable is still plugged in). These cables could optionally be hanging inside the arrival/departure bay, or remain attached to the pallet when not in use. Also, for additional safety, a pallet could contain pressure switches or other sensors that prevent it from becoming electrified when it is empty. Alternatively, contact switches for one or more (or all) wheels can be provided. An embodiment of the invention provides that either an alarm goes off or the pallet becomes unmovable if any plug is left plugged into the pallet.

Another important aspect of the present invention is notifying the parking system that an electric vehicle is approaching that desires charging so that an EV enabled pallet can be secured and sent to the entrance point. In some of the embodiments presented above, this information was entered by the driver into a kiosk or other portal upon entry. In an alternate embodiment, the controller (181) may have a connection to a telephone network or Internet. A cellular telephone could be logically tied to EV charging using caller ID, email address, or other identifier. In this case, a driver getting ready to approach a parking facility could simply speed dial a call to a special telephone number for the facility. The caller ID would be stored in a database, and would be used to reserve or secure an EV enabled pallet, and to possibly arrange billing thus avoiding the kiosk totally. This would be especially useful for daily or monthly patrons. Alternatively GPS or WiFi sensing could be used, through which the facility could sense when a regular patron is approaching either to park or to retrieve a vehicle and to start the parking process or retrieval process. In addition, with a patron's data stored in a database, the system could make sure that the correct type of charging was prepared. In still another embodiment, a camera (not shown) deployed at or near the entrance lane (111) connected to the controller (181) or kiosk (112) can recognize the license plate of an approaching vehicle as that of a repeat customer with previously established preferences which would be automatically used in lieu of all or a portion of a transaction with the kiosk (112). In other embodiments, such previously established preferences could be automatically recalled when the approach of the patron or the vehicle is detected, e.g., by a transponder on the vehicle such as an RFID, or a connection by the patron's smart phone or portable computer to a wireless network with which the controller (181) has communication.

FIG. 3 is a schematic diagram that illustrates a system, upon which embodiments of the present teachings may be implemented. A system for providing electric vehicle charging in a high-density parking system includes a carriage receptacle (163) and a bay receptacle (164). Carriage receptacle (163) is physically attached to carriage (162) of a high-density parking system to electrically connect to electric vehicle (192) supported by carriage (162). Bay receptacle (164) is physically attached to a bay (not shown) of the high-density parking system to electrically connect carriage receptacle (163) to a power source to provide electrical charging to the electric vehicle when carriage (162) is moved into the bay.

One skilled in the art can appreciate that a carriage of a high-density parking system can include, but is not limited to, a pallet, a tray, a platform, a member, a lift, or a device capable of holding a vehicle for movement and storage. One skilled in the art can appreciate that a bay of a high-density parking system can include, but is not limited to, a parking space, an electrical vehicle charging space, a storage space, a lift location, or any location in which a carriage can be placed or stored. One skilled in the art can appreciate that a receptacle can include, but is not limited to, one or more of an electric delivery box, a power source portal, a plug, a cable, an inductive coil, a wire, a cord, or any device capable of making an electrical connection.

Bay receptacle (164) electrically connects to carriage receptacle (163) using an inductive connection, for example. Bay receptacle (164) includes inductive coil (401), and carriage receptacle (163) includes inductive coil (402). Aligning axis (403) of inductive coil (401) with axis (404) of inductive coil (402) by moving carriage (162) into the bay provides the inductive connection between bay receptacle (164) and carriage receptacle (163).

In various embodiments, bay receptacle (164) is connected to carriage receptacle (163) using a physical connection. Such a physical connection is illustrated in FIG. 2, for example.

Returning to FIG. 3, in various embodiments, bay receptacle (164) and carriage receptacle (163) can each include a guide to properly position bay receptacle (164) and carriage receptacle (163) to electrically connect as carriage (162) is moved into the bay. A guide can be used to properly position bay receptacle (164) and carriage receptacle (163) for an inductive or a physical connection. A guide can include a physical, an electrical, a magnetic, or an optical device.

In various embodiments, the system can further include an electrical meter (not shown) electrically connected between the power source and bay receptacle (164) to report power usage of bay receptacle (164) through a data connection to a controller (not shown) of the high-density parking system. A controller can include, but is not limited to, a computer, a microprocessor, a microcontroller, an application specific integrated circuit, a field programmable gate array, or any device capable of executing instructions and/or sending and receiving control or data communications.

In various embodiments, carriage receptacle (163) can include two or more plugs that are located at two or more locations on carriage (162). In various embodiments, carriage receptacle (163) can include two or more plugs that provide electricity at two or more different voltages or amperages or at two or more different electrical charging payment rates. In various embodiments, the two or more different voltages can include alternating current voltages or amperages or direct current voltages or amperages. One skilled in the art can appreciate that a plug can include a cable, for example.

Carriage receptacle (163) includes plug (210) and cable (197) for connecting to plug (212) of electrical vehicle (192) to electrically connect to electrical vehicle (192). In various embodiments, carriage receptacle (163) includes plug (211) for receiving a cable from electrical vehicle (192) to electrically connect to electrical vehicle (192).

In FIG. 3, carriage receptacle (163) is electrically connected to electric vehicle (192) through a physical connection that includes cable (197). In various embodiments, carriage receptacle (163) can be electrically connected to electric vehicle (192) through a non-physical connection. A non-physical connection can include, for example, an inductive connection.

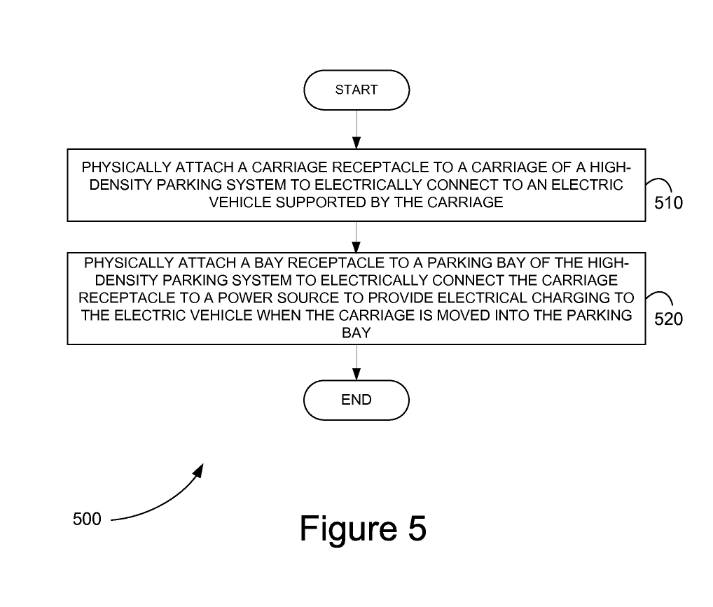

FIG. 5 is an exemplary flowchart showing a method 500 for providing electric vehicle charging in a high-density parking system, in accordance with various embodiments.

In step 510 of Method 500, a carriage receptacle is physically attached to a carriage of a high-density parking system. The carriage receptacle electrically connects to an electric vehicle supported by the carriage.

In step 520, a bay receptacle is physically attached to a bay of the high-density parking system. The bay receptacle electrically connects the carriage receptacle to a power source to provide electrical charging to the electric vehicle when the carriage is moved into the bay.

In various embodiments, method 500 can include receiving at a controller of the high-density parking system an electrical vehicle charging request that causes the controller to select the carriage and the bay. The electrical vehicle charging request is received from a parking kiosk of the high-density parking system, for example.

In various embodiments, the electrical vehicle charging request includes an identification of a user and is received from an input device. The input device can include, but is not limited to, one of a telephone modem, a network connection device, a transponder receiver, a radio-frequency identification (RFID) reader, a WiFi™ device, a proximity device reader, or a license plate reader.

In various embodiments, the electrical vehicle charging request can include an electrical charging voltage, an electrical charging amperage, or an electrical charging payment rate.

In various embodiments, the identification is used to search a database for electrical charging preferences for the user using the controller. The preferences can include, but are not limited to, an electrical charging voltage, an electrical charging amperage, or an electrical charging payment rate.

In various embodiments, a computer program product includes a non-transitory and tangible computer-readable storage medium whose contents include a program with instructions being executed on a controller of a high-density parking system so as to perform a method for providing electric vehicle charging in the high-density parking system. This method is performed by a system that includes one or more distinct software modules.

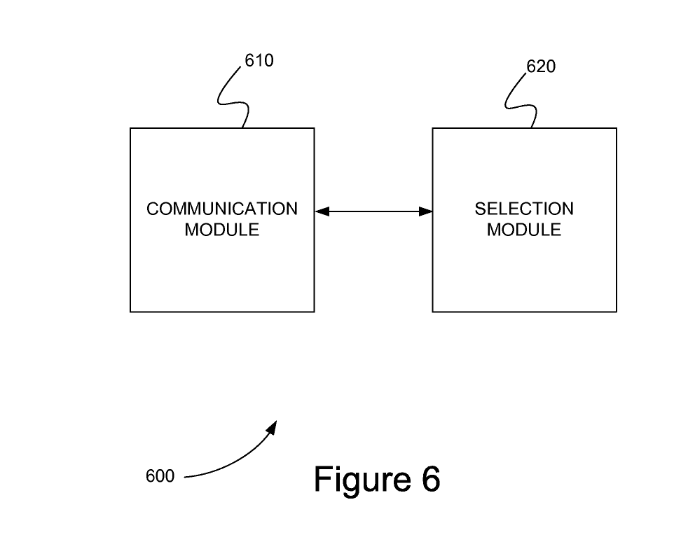

FIG. 6 is a schematic diagram of a system 600 that includes one or more distinct software modules to be executed on a controller of a high-density parking system so as to perform a method for providing electric vehicle charging in the high-density parking system, in accordance with various embodiments. System 600 includes communication module 610 and selection module 620.

Communication module 610 receives an electrical vehicle charging request.

In response to the electrical vehicle charging request, selection module 620 selects a carriage and a bay of the high-density parking system to provide electrical charging to the electric vehicle when the carriage is moved into the bay. The carriage includes a carriage receptacle physically attached to the carriage to electrically connect to an electric vehicle supported by the carriage. The bay includes a bay receptacle physically attached to the bay to electrically connect the carriage receptacle to a power source.

Several descriptions and illustrations have been provided to aid in understanding the features of the present invention. One skilled in the art will realize that numerous changes and variations are possible without departing from the spirit of the invention. Each of these changes and variations is within the scope of the present invention.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for providing electric vehicle charging in a high-density parking system, comprising:
a carriage receptacle physically attached to a carriage of a high-density parking system to electrically connect to an electric vehicle supported by the carriage; and
a bay receptacle physically attached to a bay of the high-density parking system to electrically connect the carriage receptacle to a power source to provide electrical charging to the electric vehicle when the carriage is moved into the bay.

2. The system of claim 1, wherein the bay receptacle electrically connects to the carriage receptacle using a physical connection.

3. The system of claim 1, wherein the bay receptacle electrically connects to the carriage receptacle using an inductive connection.

4. The system of claim 3, wherein the bay receptacle and the carriage receptacle each includes an inductive coil to provide the inductive connection.

5. The system of claim 1, wherein the bay receptacle and the carriage receptacle each includes a guide to properly position the bay receptacle and the carriage receptacle to electrically connect as the carriage is moved into the bay.

6. The system of claim 1, further comprising an electrical meter electrically connected between the power source and the bay receptacle to report power usage of the bay receptacle through a data connection to a controller of the high-density parking system.

7. The system of claim 1, wherein the carriage receptacle includes two or more plugs that are located at two or more locations on the carriage.

8. The system of claim 1, wherein the carriage receptacle includes two or more plugs that provide electricity at two or more different voltages or amperages or at two or more different electrical charging payment rates.

9. The system of claim 8, wherein the two or more different voltages or amperages can include alternating current voltages or amperages or direct current voltages or amperages.

10. The system of claim 1, wherein the carriage receptacle includes a cable for connecting to a plug of the electrical vehicle to electrically connect to the electrical vehicle.

11. The system of claim 1, wherein the carriage receptacle includes a plug for receiving a cable from the electrical vehicle to electrically connect to the electrical vehicle.

12. A method for providing electric vehicle charging in a high-density parking system, comprising:
physically attaching a carriage receptacle to a carriage of a high-density parking system to electrically connect to an electric vehicle supported by the carriage; and
physically attaching a bay receptacle to a bay of the high-density parking system to electrically connect the carriage receptacle to a power source to provide electrical charging to the electric vehicle when the carriage is moved into the bay.

13. The method of claim 12, further comprising receiving at a controller of the high-density parking system an electrical vehicle charging request that causes the controller to select the carriage and the bay.

14. The method of claim 13, wherein the electrical vehicle charging request is received from a parking kiosk of the high-density parking system.

15. The method of claim 13, wherein the electrical vehicle charging request includes an identification of a user and is received from an input device.

16. The method of claim 14, wherein the input device can include one of a telephone modem, a network connection device, a transponder receiver, a radio-frequency identification (RFID) reader, a WiFi™ device, a proximity device reader, or a license plate reader.

17. The method of claim 14, wherein the identification is used to search a database for electrical charging preferences for the user using the controller.

18. The method of claim 17, wherein the electrical charging preferences includes an electrical charging voltage, an electrical charging amperage, or an electrical charging payment rate.

19. The method of claim 13, wherein the wherein the electrical vehicle charging request includes an electrical charging voltage, an electrical charging amperage, or an electrical charging payment rate.

20. A computer program product, comprising a non-transitory and tangible computer-readable storage medium whose contents include a program with instructions being executed on a controller of a high-density parking system so as to perform a method for providing electric vehicle charging in the high-density parking system, the method comprising:
providing a system, wherein the system comprises one or more distinct software modules, and wherein the distinct software modules comprise a communication module and a selection module;
receiving an electrical vehicle charging request using the communication module; and
in response to the electrical vehicle charging request selecting a carriage of the high-density parking system that includes a carriage receptacle physically attached to the carriage to electrically connect to an electric vehicle supported by the carriage and a bay of the high-density parking system that includes a bay receptacle physically attached to the bay to electrically connect the carriage receptacle to a power source to provide electrical charging to the electric vehicle when the carriage is moved into the bay.
